(19) United States
(12) Patent Application Publication
(10) Pub. No.: US 2024/0419791 A1
(43) Pub. Date: Dec. 19, 2024

(54) SYSTEM FOR PROVIDING DIFFERENTIATION OF DEVICES FOR NON-ORGANIZATIONAL NETWORK MICROSEGMENTATION AND DEVICE SECURITY STATUS REPORTING

(71) Applicant: Lookout, Inc., Boston, MA (US)

(72) Inventors: Tyler S. Croak, Columbia, MD (US); Brian James Buck, Livermore, CA (US); Pritesh Kasliwal, Apex, NC (US)

(21) Appl. No.: 18/336,793

(22) Filed: Jun. 16, 2023

(51) Int. Cl. G06F 21/55

(52) U.S. Cl. CPC G06F 21/554; G06F 2221/034

(57) ABSTRACT

A system providing differentiation of devices for home network microsegmentation and device security status reporting is disclosed. The system gathers characteristic data for devices of a non-organizational network. Based on the characteristic data, the system determines whether the devices are associated with an organizational network. If a device is associated with the organizational network, the system automatically generates a microsegmented organizational network that is separately accessible from the non-organizational network and assigns each device associated with the organizational network to the microsegmented organizational network. The system analyzes communications associated with the devices and may determine a risk score for the non-organizational network based on the communications and/or characteristics of the devices and networks. Based on the risk score, the system provisions security controls for the organizational network to each device of the microsegmented organizational network and enables each such device to communicate subject to the security control.

### FIELD OF THE TECHNOLOGY

At least some embodiments disclosed herein relate to service differentiation technologies, microsegmentation technologies, secure access service edge technologies, network security technologies, and more particularly, but not limited to, a system for providing differentiation of devices for non-organizational network microsegmentation and device security status reporting.

### BACKGROUND

As society has become more technologically-advanced, remote and hybrid working has become common and accepted within workforces of various types of businesses. Remote and hybrid working has, in many instances, provided businesses with greater worker efficiency, such as by reducing or eliminating the need to commute to physical offices, enabling meetings to be conducted by video conferencing technologies, and fostering increased worker satisfaction. Despite the foregoing benefits, remote and hybrid working does come with challenges, including challenges relating to security and privacy. For example, remote and hybrid working expose organizational networks to potential malware attacks and inconsistent levels of security for home networks of workers that connect to the organizational networks, while also exposing employees to potential privacy intrusions relating to non-organizational information and activities conducted on home networks.

Currently, certain technologies exist for organizations to protect edge network devices, such as, but not limited to, gateways, mesh routers, switches, and end user devices. For example, technologies such as secure access service edge (SASE) protect such devices from malware attacks by providing an integrated security and network connectivity cloud-platform in a single organizational service. SASE enables organizations to unify network and security tools in a single management console and may provide functionality such as firewall as a service (FaaS), software as a service (SaaS), secure web gateways (SWG), cloud access security brokers (CASBs), zero-trust network access (ZTNA), among other functionalities. While SASE and other security and network connectivity technologies provide for numerous benefits, attackers may still access the organization in a variety of ways. For example, an attacker may first infiltrate a non-work device in a home network by performing a variety of infiltration techniques, such as conducting port scanning, exploiting device or network vulnerabilities, exploiting weak login credentials, joining compromised devices to the home network, among other techniques. Once a device is compromised, the device may be used to take over a work-from-home device connected to and communicating with the organization's network. Additionally, workers may not be comfortable with existing technologies inspecting, analyzing, and/or scanning all of the data coming from all the devices of the workers' home networks. Furthermore, inspecting, analyzing, and/or scanning all sets of data communicating from devices in a worker's home network is resource intensive and impacts performance of the network. Based on at least the foregoing, technologies may be enhanced to provide greater security and privacy for organizational and non-organizational networks, while also utilizing fewer computer resources and provider greater versatility.

### BRIEF DESCRIPTION OF THE DRAWINGS

The embodiments are illustrated by way of example and not limitation in the figures of the accompanying drawings in which like references indicate similar elements.

FIG. 1 illustrates an exemplary system for providing differentiation of devices for non-organizational network microsegmentation and device security status reporting according to embodiments of the present disclosure.

FIG. 2 illustrates further componentry and features of the system of FIG. 1 for providing differentiation of devices for non-organizational network microsegmentation and device security status reporting according to embodiments of the present disclosure.

FIG. 3 illustrates an exemplary method for providing and facilitating differentiation of devices for non-organizational network microsegmentation and device security status reporting according to embodiments of the present disclosure.

FIG. 4 illustrates an exemplary method for determining a configuration and profile type of a device to determine whether the device can interact with an organizational network according to embodiments of the present disclosure.

FIG. 5 illustrates an exemplary method for probing a non-organizational network externally and internally to identify misconfiguration of the non-organizational network according to embodiments of the present disclosure.

FIG. 6 illustrates a schematic diagram of a machine in the form of a computer system within which a set of instructions, when executed, may cause the machine to provide differentiation of devices for home network microsegmentation and device security status reporting according to embodiments of the present disclosure.

### DETAILED DESCRIPTION

The following disclosure describes various embodiments for a system 100 and accompanying methods for providing differentiation of devices for non-organizational network microsegmentation and device security status reporting. The system 100 and methods may be utilized to assess the security of a non-organizational network (e.g., a home network, a remote working network, a shared workspace network, and/or other network that may not belong to, may not be connected to, and/or may not be under the control of an organization) from both the inside and the outside, while simultaneously ensuring privacy of a user that may work for an organization. Embodiments disclosed herein may integrate network and security services, such as, but not limited to, secure access secure edge (SASE) capabilities and/or security controls, at a non-organizational networking device (e.g., Wi-Fi mesh devices or edge devices) that typically connects to or takes over non-organizational router (e.g., home or other premises) functionality. In certain embodiments, the system 100 and methods may be utilized to analyze (or inspect) only characteristic data related to work devices that communicate with an organization instead of all of the data traversing a non-organizational network that may be unrelated to the organization. Characteristic data may be obtained from devices of a non-organizational network of a user and examined at both the router level and by a proxy (e.g., a component of SASE) to evaluate whether or not a user device is related to the organization or not. In certain embodiments, the characteristic data may be obtained by inspecting traffic coming to or from the devices of the non-organization network that are communicating with an organizational network. In certain embodiments, SASE and/or other security service capabilities may also be embedded at the router level as well. In certain embodiments, if the inspecting, analysis and/or examination of communications (e.g., traffic) results in an assessment that the user device is related to the organization and data being accessed by the user device is related to work activities, security capabilities of the system 100 and methods, such as, but not limited to, SASE, may be utilized to assess the communication(s) of a work device and apply security measures if needed, such as to comply with organizational policies. In certain embodiments, for example, assessing the communications(s) may include analyzing, examining, and/or inspecting characteristic data, such as, but not limited to, data relating to communications (e.g., traffic) from or to a device to determine whether the device is associated with an organizational network or non-organizational network. For example, based on such inspections and/or analyses, a device may be assessed as being associated with an organizational network if the traffic type is of a type permitted and/or utilized by the organizational network, the applications that the device is interacting with are organization permitted and/or utilized applications, the devices that the device is communicating with are organization devices, and/or other associations with the organization. Based on at least the foregoing, the privacy of the workers may still be maintained by the system 100 and methods because, in certain embodiments, the security assessment may be performed for only work-related communication on work-related devices and not for personal communications, such as data and communications coming from personal devices (e.g., non-organizational devices), other devices, and/or video streaming equipment that may be connected to a user's home network.

In certain embodiments, the characteristic data gathered from the user devices may primarily be examined at the network, session, transport, and application layers. In certain embodiments, characteristic data that is gathered, obtained, and/or received may include, but is not limited to, data and/or metadata (i.e., data that describes and/or provides context for data) associated with data being accessed or attempting to be accessed by a device associated with an organizational network (e.g., a network that is the property of, under the control of, and/or otherwise associated with a commercial enterprise, a non-profit organization, a small business, a midsize business, a large business, a government organization, any type of entity, or a combination thereof), data and/or metadata associated with applications executing on the device associated with the organizational network (e.g., what data or content that the applications are attempting to access or are accessing, the software features and functionality provided by the applications, the types of software features being utilized, the types of applications being used, what hardware the applications have access to and/or are accessing, and other data associated with applications), network activity conducted by the device (e.g., what ports are being used, what websites are attempting to be accessed or are being accessed, what connections are attempting to be established or are established, what content is being downloaded and/or uploaded, what networks and/or devices that the device is connected to or is attempting to connect to, and/or other network activity), time-of-day of the user of the device, presence and/or use of security tools on the device and/or interacting with the device (e.g., antivirus software being used or accessed, firewalls being used, various types of protocols being used (e.g., for security, communication, etc.), files being modified and/or accessed by the device, a type of the device, network connections made by the device, data requested by the device, content accessed by the device (e.g., enterprise websites and/or databases), any type of traffic and/or communication coming to or from the device, telemetry data, any other data, or a combination thereof. In certain embodiments, determining the association within the non-organizational network of a user device with an organization may involve utilizing proprietary heuristics and intelligent network analysis. To that end, to provide differentiation of devices for microsegmentation involving separation of non-organizational devices from organizational devices into separate networks having different policies and/or network access capabilities (e.g., non-organizational networks and organizational networks), a variety of processes and techniques may be utilized by the system 100 and methods to determine whether a user device is associated with an organization or for the user's personal use. For example, such processes may include, but are not limited to, analyzing and classifying network traffic related to endpoint agents or security tools that are installed on the user device, identifying and classifying network communications (e.g., traffic) associated with corporate or cloud provider websites accessed that are associated with the organization, identifying based on network activity, time-of-day use of the device, and frequency of use of third party tools that may determine work-related activities, and raw telemetry relating to processes, file modifications, registry changes and network connections. In certain embodiments, if traffic types for communications correspond to traffic types utilized or facilitated by an organization and/or organization network, applications used. In addition to analyzing specific types of characteristic data, the system 100 and methods may analyze other types of characteristic data as well including, but not limited to the identity information associated with the user device. In certain embodiments, device status reporting may encompass determining whether a device is associated with an organizational network or a non-organizational network and indicating the status at any given point of time and reporting the status to the organization, such as to the organization's network. In certain embodiments, the system may adjust the status (e.g., association with the organizational or non-organizational network in real-time or whenever the device receives and/or sends a communication).

A variety of embodiments of the present disclosure may be utilized to facilitate the differentiation of devices (and networks) for conducting an assessment, such as assessments facilitated via SASE inspection and/or analysis of characteristic data. In certain embodiments, an assessment may involve determining, based on the inspection and/or analysis of characteristic data, whether a device is to be associated with an organizational network or a non-organizational network. In certain embodiments, the system 100 and methods may utilize a software agent at a non-organizational network device (e.g., edge device 120 or other device) that can create a profile such that all of the work-related devices within the non-organizational network automatically get assigned to a separate microsegmented organizational network. The foregoing process of creating the separate microsegmented organizational network within the non-organizational network that is separately accessible from the non-organizational network may be referred to as microsegmentation in the present disclosure. In certain embodiments, the system 100 and methods may create or support two separate networks for non-organizational-related devices and work-related devices respectively, and the microsegmented organizational network may automatically be created from the non-organizational network by the system 100 and methods. In certain embodiments, the inspection and/or analysis utilized for the assessment conducted by the system 100 and methods may be performed only for microsegmented organizational networks and not for a user's non-organizational network. In certain embodiments, hybrid devices, such as mobile phone devices, may be used for both work and personal use and may be assigned to the microsegmented organizational network because work data is being regularly sent and/or received using such devices. In certain embodiments, the organization may control what is inspected, analyzed, and/or scanned and what is not for devices having hybrid profiles. In certain embodiments, a secure web gateway (SWG) on a mobile client may be configured to perform the inspection, analysis, and/or assessment.

In certain embodiments, the microsegmentation may be utilized to prevent communication of various types of traffic between work devices and non-work devices to mitigate an attacker who has compromised a non-work device from moving to a work device, and, for privacy reasons and performance reasons, to not inspect and/or analyze non-work devices or traffic from non-work devices. Based on at least the foregoing, the functionality provided by the system 100 and methods provides a combined privacy and security and performance problem and solution. In certain embodiments, traffic from non-work devices may still be analyzed, monitored, and/or scanned for security reasons. For example, in certain embodiments, such traffic may be analyzed, monitored, and/or scanned utilizing the system 100 and methods to ensure that there is no communication from non-work devices to command and control servers of malicious attackers. In certain embodiments, if non-work devices attempt to communicate with malicious attackers, traffic associated with such attempted communications may be blocked by the systems and methods. In certain embodiments, in order to preserve privacy of non-work devices, the actual content of the non-work device traffic may not be inspected or viewed by administrators of the system. In certain scenarios, there may be more risk (i.e., increased attack surface) from a non-organizational network that has more devices connected to it, and the organizational policy (e.g., rules, regulations, restrictions, and/or conditions by which the organization operations and/or requires for devices, programs, systems to abide by to connect to the organizational network and/or communication with the organizational network) may differ for that non-organizational network. As a result, there may be additional security controls, such as dynamic firewall rules, provisioned to a work device on the non-organizational network. In certain scenarios, there may also be an increase in risk because of the browsing behavior by someone (e.g., the remote worker or someone else in the worker's household) connected to the network. In consideration of privacy, the actual history of browsing behavior may not be sent to the organization. Instead, for example, the characteristic data sent to the organization may relate to whether risky sites have been visited or not, and with what frequency, thereby avoiding inspection and/or analysis of the traffic from non-organizational devices.

As another example, based on a worker that has four laptops in his home (e.g., detected by a software agent), the system 100 and methods may determine that there are risky sites that have been visited from the work-related devices. As a result, the system 100 and methods may determine that the entire work profile associated with the work-related devices may require additional security controls, such as additional firewall rules, such as, but not limited to, preventing inbound port scans, Server Message Block (SMB) protocol requests, etc., which may all be based on a determined risk level. In certain embodiments, such as where the remote worker has consented to the inspecting, analyzing, assessment, and/or potentially scanning of communications (e.g., traffic) on non-work devices, for the purposes of protecting those devices and users, the remote worker may allow an indication of visits to general categories of risky sites (or applications or devices) without disclosing what the individual sites actually are. This may be relevant because it may affect the riskiness of the entire non-organizational network, and therefore may lead to a determination to adjust the security controls on either the microsegmentation process itself and/or the individual work devices.

In certain embodiments, the organization may be provided with a snapshot of the worker and their home and utilize the snapshot as an informing factor of what the risk situation is for the worker's home. For example, the worker may be married and have three kids of various particular ages that participate in various types of activities. For such a snapshot, in the event that the parental controls fail, there may be a higher risk level for the worker's household than for a household with a single couple where both individuals are security-conscious professionals. In certain embodiments, for example, a risk score may be formulated using the information of the snapshot of the users and devices within the household.

Additional embodiments are disclosed in the present disclosure. For example, when analyzing the configuration of the device (e.g., a remote device, a device at the home of a user, etc.) at a non-organizational network regarding, e.g., file sharing, the organization (e.g., via a software agent of the enterprise executing on the device) may provide an additional level of security that does allow sharing among devices which are associated with a work profile, but not from devices in the work profile to devices in a non-organizational profile. The foregoing conveys the notion of host-network-communication microsegmentation versus network appliance level microsegmentation. In certain embodiments, communications (e.g., inbound or outbound) may be allowed only within specific profiles and/or device-sets. For example, a networked printer might be in the non-organizational profile, however, printing from a work profile device may be allowed. As another example, network sharing in one direction may be allowed by the system 100 and methods. For example, certain devices may be allowed to activate network sharing functionality so that network sharing is only allowed from certain internet protocol addresses within the non-organizational network. In certain embodiments, a device with network sharing enabled may allow another device to connect to and/or interact with it, however, for a device for which network sharing is not enabled, such a device may not be able to connect to another device associated with the organizational network. In certain embodiments, microsegmentation may be accomplished by configuration of a network gateway device, virtually by allowing or disallowing communications between devices in different microsegments, or a combination thereof.

In certain embodiments, a system for providing differentiation of devices for non-organizational network microsegmentation and device security status reporting is provided. In certain embodiments, the system may include a memory and a processor configured to perform various operations and support the functionality of the system. In certain embodiments, the system may be configured to gather characteristic data associated with a device connected to a non-organizational network. Additionally, the system may be configured to determine, based on the characteristic data, whether the device is associated with an organizational network. In certain embodiments, the system may be configured to automatically facilitate, based on a determination that the device is associated with the organizational network, generation of a microsegmented organizational network from the non-organizational network that is separately accessible from the non-organizational network. In certain embodiments, the system may be configured to assign the device to the microsegmented organizational network and inspect and/or analyze, by utilizing secure access service edge services (or other services) of the organizational network, communications from the device of the microsegmented organizational network. In certain embodiments, the system may be configured to determine a risk score for the non-organizational network, the microsegmented organizational network, or a combination thereof, based on the inspection and/or analysis of the communications from the device, a characteristic of the device, a characteristic of the non-organizational network, or a combination thereof. In certain embodiments, the system may be configured to provision a security control associated with the organizational network to the device of the microsegmented organizational network based on the risk score. In certain embodiments, the system may be configured to enable the device of the microsegmented organizational network to communicate with the security control.

In certain embodiments, the system may be configured to generate an organizational profile (or work profile) for the device based on the determination that the device is associated with the organizational network. In certain embodiments, the organizational profile may associate the device with the organizational network. In certain embodiments, the system may be configured to generate a non-organizational profile for the device associating the device with the non-organizational network if the device is determined to not be associated with the organizational network. In certain embodiments, the system may be configured to determine whether a user associated with the device has consented to inspection, analysis, and/or scanning of the device of the non-organizational network by the organizational network. In certain embodiments, the system may be configured to prevent, if the user has not consented, inspection, analysis, and/or scanning of communications made by the device of the non-organizational network by the organizational network. In certain embodiments, the system may be configured to conduct limited inspection and/or analysis of communications (e.g., traffic) from or to a device of the non-organizational network if the user has consented to the inspection of communications of the device of the non-organizational network by the organizational network. In certain embodiments, the system may be configured to utilize an output generated based on the limited inspection of the communications to or from the device of the non-organizational network to determine the risk score for the non-organizational network, the microsegmented organizational network, or a combination thereof.

In certain embodiments, the system may be configured to prevent the device of the microsegmented organizational network from communicating with a different device of the non-organizational network. In certain embodiments, the system may be configured to generate a hybrid profile for the device if the device is determined to be associated with the organizational network and the non-organizational network (e.g., a mobile device utilized for work and for personal use). In certain embodiments, the system may be configured to inspect and/or analyze, based on the hybrid profile, a first portion of the communications associated with the device occurring in the microsegmented organizational network. In certain embodiments, the system may be configured to not inspect and/or analyze a second portion of the communications associated with the device occurring in the non-organizational network. In certain embodiments, the system may be configured to enable a device of a microsegmented organizational network to communicate with at least one other device of the microsegmented organizational network.

In certain embodiments, the system may be configured to analyze various characteristics when determining whether to associate devices and/or networks with an organization. For example, in certain embodiments, characteristics of a non-organizational network may include a quantity of devices in the non-organizational network, a type of internet connection supported by the non-organizational network, a service provider of the non-organizational network, a type of edge device of the non-organizational network, a bandwidth of the non-organizational network, security hardware of the non-organizational network, security software of the non-organizational network, or a combination thereof. As another example, characteristics of a device that may factor into the determination may include a type of the device, a communication capability of the device, a type of componentry of the device, a software version of software of the device, whether the device is communicating with a type of device, or a combination thereof.

In certain embodiments, a method for providing differentiation of devices for non-organizational network microsegmentation and device security status reporting is provided. In certain embodiments, the method may include analyzing, by utilizing instructions from a memory that are executed by a processor, characteristic data associated with a device connected to a non-organizational network. In certain embodiments, the method may include determining, based on the characteristic data, whether the device is associated with an organizational network. In certain embodiments, the method may include creating, based on determining that the device is associated with the organizational network, a microsegmented organizational network from the non-organizational network that is separately accessible from the non-organizational network. In certain embodiments, the method may include inspecting and/or analyzing, by utilizing the organizational network, communications associated with the device of the microsegmented organizational network. In certain embodiments, the method may include provisioning a security control associated with the organizational network to the device of the microsegmented organizational network based on the communications inspected and/or analyzed by utilizing the organizational network. In certain embodiments, a security control may include, but is not limited to, dynamically changing host-based or network-based firewall rules within a router configuration of a microsegmented network (e.g., rules within the operating system that may optionally utilize a software agent to block access by devices to an organizational network), conducting device containment (e.g., to block a device from communicating with other devices in the same network as devices of the organizational network or other networks (including even the Internet), blocking access for the entire non-organizational network to the organizational network (e.g., via firewall rules of the organizational network), premises containment (e.g., restrict any device of a certain premises from communication with the organizational network), restricting the types of protocols that may be utilized by a device for communication or for other purposes, restricting the types of applications that the device may access and/or utilize, restricting access to certain types of data, initiate a malware or virus scan (e.g., such as via an agent controlled by the organization that is installed on the device), prevent a device from accessing certain content (e.g., websites), any type of security control, or a combination thereof. In certain embodiments, provisioning a security control may include having the organizational network and/or a software agent on the device set security controls, policies, restrictions, or a combination thereof, for the device. In certain embodiments, the method may include enabling the device of the microsegmented organizational network to communicate with the organizational network using the security control.

In certain embodiments, the method may include probing the non-organizational network from outside the non-organizational network to determine whether the non-organizational network is misconfigured with respect to at least one policy associated with the organizational network. In certain embodiments, the method may include probing the non-organizational network from within the non-organizational network to determine whether the non-organizational network is misconfigured with respect to the at least one policy associated with the organizational network. In certain embodiments, the method may include facilitating reconfiguration of the non-organizational network to comply with the at least one policy associated with the organizational network by updating a network configuration of the non-organizational network, applying a software update to the non-organizational network, enabling a privacy feature, providing user instructions to a user of the device to reconfigure the non-organizational network, conducting a speed test of the non-organizational network, modifying an identifier of the non-organizational network, prevent filing sharing with certain types of systems, or a combination thereof. In certain embodiments, the method may include determining compliance with at least one policy of the organizational network by inspecting communications traversing the non-organizational network, the microsegmented organizational network, or a combination thereof, without accessing information a user of the non-organizational network designates as private, types of information indicated as private according to the at least one policy or the organizational network, or a combination thereof.

In certain embodiments, a non-transitory computer readable medium comprising instructions, which, when loaded and executed by a processor, cause the processor to be configured to perform operations. In certain embodiments, the processor may be configured to receive characteristic data associated with a device connected to a non-organizational network. In certain embodiments, the processor may be configured to determine, based on the characteristic data, whether the device is associated with an organizational network. In certain embodiments, the processor may be configured to facilitate, based on determining that the device is associated with the organizational network, generation of a microsegmented organizational network separately accessible from the non-organizational network. In certain embodiments, the processor may be configured to assign the device to the microsegmented organizational network. In certain embodiments, the processor may be configured to inspect and/or analyze, by utilizing the organizational network, at least one communication associated with the device of the microsegmented organizational network. In certain embodiments, the processor may be configured to determine a risk score for the non-organizational network based on the inspecting and/or analyzing of the communications associated with the device, a characteristic of the device, a characteristic of the non-organizational network, a characteristic of the microsegmented organizational network, any characteristic data, or a combination thereof. In certain embodiments, the processor may be configured to provision a security control associated with the organizational network to the device of the microsegmented organizational network in accordance with the risk score. In certain embodiments, the processor may be configured to adjusting the security control as the risk score for the non-organizational network changes over time.

In certain embodiments, the processor may be configured to receive additional characteristic data associated with the device. In certain embodiments, the processor may be configured to remove the device from the microsegmented organizational network if the additional characteristic data indicates that the device is no longer associated with the organizational network. In certain embodiments, the processor may be configured to enable the device of the microsegmented organizational network to interact with another device of the non-organizational network in accordance with the security control, at least one policy of the organization, or a combination thereof.

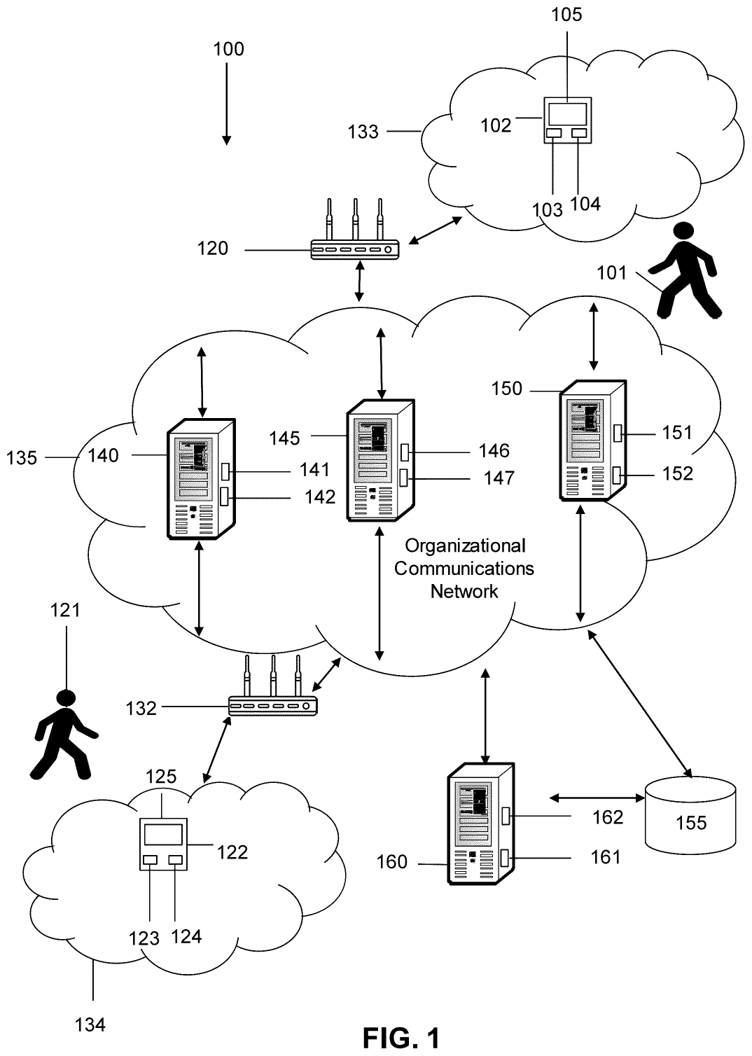

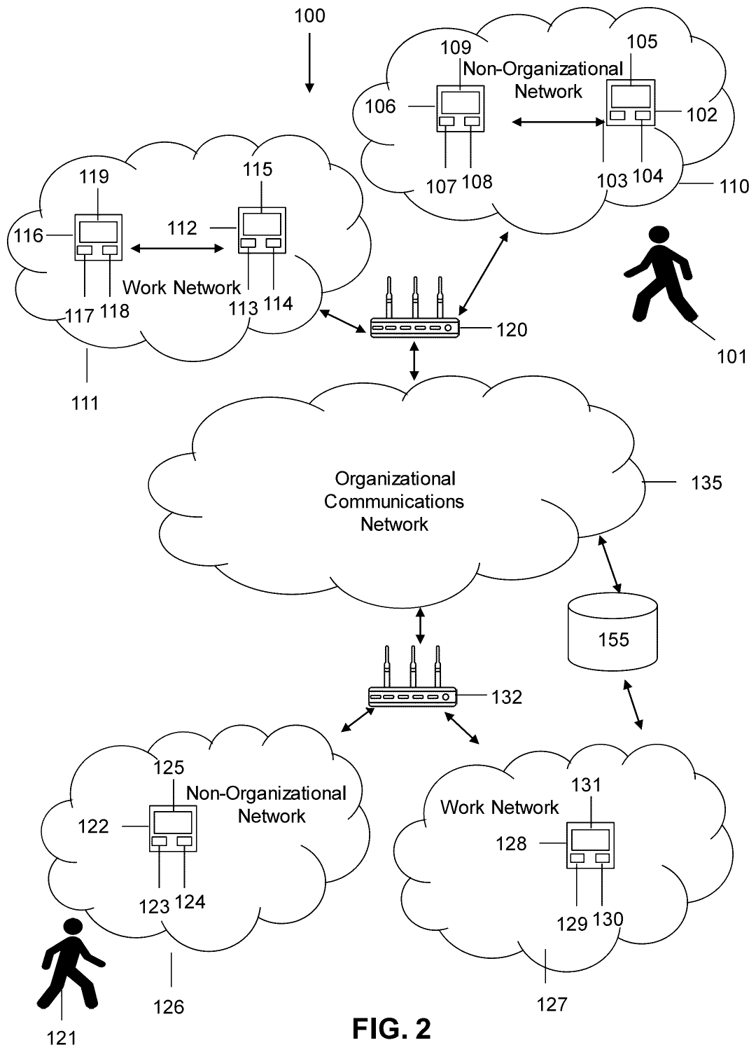

As shown in FIGS. 1-2, a system 100 for providing differentiation of devices for microsegmentation and device status reporting is provided. Notably, the system 100 may be configured to support, but is not limited to supporting, security systems and services (e.g., SASE and/or other security systems and services), cloud computing systems and services, privacy systems and services, firewall systems and services, internet security systems and services, data analytics systems and services, data collation and processing systems and services, artificial intelligence services and systems, machine learning services and systems, neural network services, surveillance and monitoring systems and services, autonomous vehicle applications and services, keyless entry via mobile application systems and services, smartphone pairing for navigation applications and services, text messaging services and applications, contact sharing applications and services, automotive performance measurement applications and services (e.g., OBD II interface, electric charging operation applications, etc.), mobile applications and services, alert systems and services, content delivery services, satellite services, telephone services, voice-over-internet protocol services (VOIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. In certain embodiments, the first user 101 may utilize the first user device 102 to access services, applications, and/or content of an organizational network (e.g., communications network 135). As another example, the first user device 102 may be utilized to access an application, devices, and/or components of the system 100 that provide any or all of the operative functions of the system 100.

In certain embodiments, the first user 101 may be a person, a robot, a humanoid, a program, a computer, any type of user, or a combination thereof, that may be located in a particular environment. In certain embodiments, the first user 101 may be a person that is a worker of an organization and may want to utilize the first user device 102 to conduct various types of activities for the organization using the first user device 102 and the first user's 101 non-organizational network 133. For example, such activities may include, but are not limited to, drafting digital documents, communicating with other workers of the organization, accessing organizational data and documents, and/or performing any other activities.

In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a server, a mobile device, a smartphone, a smart watch, a voice-controlled-personal assistant, a physical security monitoring device (e.g., camera, glass-break detector, motion sensor, etc.), an internet of things device (IoT), appliances, a solar panel, a garage door opener, an autonomous vehicle, and/or any other type of computing device. Illustratively, the first user device 102 is shown as a computer in FIG. 1. In certain embodiments, the first user device 102 may be utilized by the first user 101 to control, access, and/or provide some or all of the operative functionality of the system 100. For example, a software agent of the organization may be configured to execute on the first user device 102 and the software agent may be utilized to control communications transmitted to or from the first user device 102, control actions taken by the first user 101, deploy security measures, perform any other functions, or a combination thereof.

In addition to using first user device 102, the first user 101 may also utilize and/or have access to any number of additional user devices. As with first user device 102, the first user 101 may utilize the additional user devices to transmit signals to access various online services and content and/or access functionality provided by an organization. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, any type of sensors, or a combination thereof.

The first user device 102 and/or additional user devices may belong to and/or form a communications network 133, which may be the first user's 101 non-organizational network. In certain embodiments, the communications network 133 may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 (e.g., communications network 135) and/or outside the system 100. In certain embodiments, the first user device 102 and/or additional user devices may be devices with respect to the organizational network of the organization.

In certain embodiments, the first user device 102 and additional user devices belonging to the communications network 133 may share and exchange data with each other via the communications network 133. For example, the user devices may share information relating to the various components of the user devices, information associated with images and/or content accessed and/or recorded by the first user 101 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying other types of profiles (e.g., non-organizational profile, work profile, etc.), information identifying the number of devices in the communications network 133, information identifying devices being added to or removed from the communications network 133, any other information, or any combination thereof.

In certain embodiments, the communications network 133 may be configured to configured to include a non-organizational network 110 and a microsegmented organizational network 111, which together may form a shared network. In certain embodiments, the non-organizational network 110 may be a network that may not be an organizational network, may not be connected to an organizational network may not be interacting with an organizational network, or a combination thereof. In certain embodiments, the non-organizational network may include home, personal, and/or other devices of a user, a remote working station, shared workspace devices, other devices, or a combination thereof. In certain embodiments, the microsegmented organizational network 111 may be a network that may be connected to an organizational network, may be configured to interact with an organizational network, may be subject to the organizational policies of the organization and/or organizational network, or a combination thereof. In certain embodiments, the non-organizational network 110 may share the same login credentials and characteristics as the communications network 133. In certain embodiments, the non-organizational network 110 may be a sub-network within the communications network 133. In certain embodiments, the microsegmented organizational network 111 may be automatically generated by the organization, such as by utilizing resources and functionality of the communications network 135. In certain embodiments, the microsegmented organizational network 111 may be generated by utilizing a software agent executing on a device of the non-organizational network 133 (or other network). In certain embodiments, the microsegmented organizational network 111 may be configured to have different login credentials and characteristics than the non-organizational network 133 (or non-organizational network 110). In certain embodiments, the microsegmented organizational network 111 may be configured by the organization to conform with organizational policies (e.g., rules, restrictions, conditions, such as those relating to interaction with an organizational network) required by the organization for working, for example. In certain embodiments, devices in the microsegmented organizational network 111 may be prevented from communicating with devices in the non-organizational network 110 and vice versa. In certain embodiments, devices in the microsegmented organizational network 111 may be configured to have limited interactions with devices in the non-organizational network 110, such as depending on the organizational policy.

In certain embodiments, the non-organizational network 110 may include devices that may not be authorized to be in the microsegmented organizational network 111. In certain embodiments and for illustration purposes only, the first user device 102 and a second user device 106 may be in the non-organizational network 110, however, any number of user devices may be in the non-organizational network 110. In certain embodiments, the second user device 106 may include a memory 107 that includes instructions, and a processor 108 that executes the instructions from the memory 107 to perform the various operations that are performed by the second user device 106. In certain embodiments, the processor 108 may be hardware, software, or a combination thereof. The second user device 102 may also include an interface 105 (e.g. screen, monitor, graphical user interface, etc.) that may enable the first user 101 to interact with various applications executing on the second user device 106 and to interact with the system 100.

In certain embodiments, the microsegmented organizational network 111 may include a third user device 112 and a fourth user device 116, however, any number of user devices may be in the microsegmented organizational network 111. In certain embodiments, the third user device 112 may include a memory 113 that includes instructions, and a processor 114 that executes the instructions from the memory 113 to perform the various operations that are performed by the third user device 112. In certain embodiments, the processor 114 may be hardware, software, or a combination thereof. The third user device 112 may also include an interface 115 (e.g. screen, monitor, graphical user interface, etc.) that may enable the first user 101 to interact with various applications executing on the third user device 112 and to interact with the system 100. In certain embodiments, the fourth user device 116 may include a memory 117 that includes instructions, and a processor 118 that executes the instructions from the memory 117 to perform the various operations that are performed by the fourth user device 116. In certain embodiments, the processor 118 may be hardware, software, or a combination thereof. The fourth user device 116 may also include an interface 119 (e.g. screen, monitor, graphical user interface, etc.) that may enable the first user 101 to interact with various applications executing on the fourth user device 116 and to interact with the system 100. In certain embodiments, the microsegmented organizational network 111 and/or the non-organizational network 110 may communicate with the edge device 120 to gain access to other networks, such as, but not limited to, the communications network 135.

In certain embodiments, the system 100 may include an edge device 120, which the first user 101 may access to gain access to the organizational network of the organization. In certain embodiments, the edge device 120 may be or may include, network servers, routers, gateways, switches, media distribution hubs, signal transfer points, service control points, service switching points, firewalls, routers, nodes, computers, proxy device, mobile devices, or any other suitable computing device, or any combination thereof. In certain embodiments, the edge device 120 may connect with any of the devices and/or componentry of the organizational network (i.e., communications network 135) and/or non-organizational network. In certain embodiments, the edge device 120 may be provided by and/or be under the control of a service provider, such as an internet, television, telephone, and/or other service provider of the first user 101. In certain embodiments, the edge device 120 may be provided by and/or be under control of the organization. In certain embodiments, the system 100 may operate without the edge device 120 and the first user device 102 may operate as an edge device, such as if a software agent of the organization is executing on the first user device 102.

In addition to the first user 101, the system 100 may also include a second user 121. The second user 121 may be similar to the first user 101 and may work for an organization and may seek to work from home. In certain embodiments, the fifth user device 122 may be utilized by the second user 121 to transmit signals to request various types of content, services, and data provided by and/or accessible by communications network 135 or any other network in the system 100. In further embodiments, the second user 121 may be a robot, a computer, a vehicle (e.g. semi or fully-automated vehicle), a humanoid, an animal, any type of user, or any combination thereof. The fifth user device 122 may include a memory 123 that includes instructions, and a processor 124 that executes the instructions from the memory 123 to perform the various operations that are performed by the second user device 122. In certain embodiments, the processor 124 may be hardware, software, or a combination thereof. The fifth user device 122 may also include an interface 125 (e.g. screen, monitor, graphical user interface, etc.) that may enable the first user 101 to interact with various applications executing on the fifth user device 122 and, in certain embodiments, to interact with the system 100. In certain embodiments, the fifth user device 122 may be a computer, a laptop, a set-top-box, a tablet device, a server, a mobile device, a smartphone, a smart watch, an autonomous vehicle, and/or any other type of computing device. Illustratively, the fifth user device 122 is shown as a mobile device in FIGS. 1 and 2. In certain embodiments, the fifth user device 122 may also include sensors, such as, but are not limited to, cameras, audio sensors, motion sensors, pressure sensors, temperature sensors, light sensors, humidity sensors, any type of sensors, any type of Internet of Things (IoT) devices, any smart devices, or a combination thereof. In certain embodiments, the second user 121 may also utilize a sixth user device 128, which may include a memory 129, processor 130, and interface 131, which may be similar to the other user devices.

In certain embodiments, the second user's 121 non-organizational network may be non-organizational network 133. In certain embodiments, the non-organizational network 133 may be the same as non-organizational network 126, however, in certain embodiments, the non-organizational network 126 may be a sub-non-organizational network of non-organizational network 133. In certain embodiments, the microsegmented organizational network 127 may be created from the non-organizational network 133, such as by actions taken by the organizational network (i.e., communications network 135) to ensure that user devices utilized for work or tasks for the organization are conducted within the confines of microsegmented organizational network 127. In certain embodiments, the microsegmented organizational network 127 may have separate login credentials from non-organizational network 126 and/or 133. In certain embodiments, the system 100 may include edge device 132, which may be utilized by the non-organizational network 126, 133 and/or microsegmented organizational network 127 to communicate with other networks, such as communications network 135, and/or devices, programs, and/or systems that are external to the non-organizational network 126,133 and/or microsegmented organizational network 127.

In certain embodiments, the user devices described herein may have any number of software functions, applications and/or application services stored and/or accessible thereon. For example, the user devices may include applications for controlling and/or accessing the operative features and functionality of the system 100, applications for controlling and/or accessing any device of the system 100, interactive social media applications, biometric applications, cloud-based applications, VOIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 121 to readily interact with the software applications. The software applications and services may also be utilized by the first and/or second users 101, 121 to interact with any device in the system 100, any network in the system 100, or any combination thereof. In certain embodiments, user devices may include associated telephone numbers, device identities, network identifiers (e.g., IP addresses, etc.), and/or any other identifiers to uniquely identify the user devices.

The system 100 may also include a communications network 135. The communications network 135 may be under the control of an organization and may include resources (e.g., data, documents, computing resources, applications, and/or any other resources) of the organization. The communications network 135 of the system 100 may be configured to link any number of the devices in the system 100 to one another. For example, the communications network 135 may be utilized by the third user device 112 of the microsegmented organizational network 111 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VOLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

In certain embodiments, the communications network 135 may be configured to deploy security services (e.g., SASE and/or other security services), which may be utilized to probe the non-organizational networks 133, 134, 110, 126 and/or the microsegmented organizational networks 111, 127. In certain embodiments, the SASE services may include security services, network connectivity services, device monitoring services, and/or any other SASE services. In certain embodiments, the resources of the communications network 135 may be utilized to create the microsegmented organizational networks 127, 111 within the corresponding non-organizational networks 134, 133. In certain embodiments, the communications network 135 may only be accessed by the microsegmented organizational networks 111, 127 and/or user devices connected to the microsegmented organizational networks 111, 127. In certain embodiments, the communications network 135 may be configured to provide virtual private network services, determine configurations of the non-organizational networks 133, 134, 110, 126 and/or microsegmented organizational networks 111, 127 and devices connected thereto, generate profiles for devices in the networks, inspect, analyze, and/or scan the non-organizational networks 133, 134, 110, 126 and/or microsegmented organizational networks 111, 127 and devices connected thereto, prevent communications between the non-organizational networks 133, 134, 110, 126 and/or microsegmented organizational networks 111, 127, determine risk scores (discussed below) for the networks and/or users, provision security controls and/or security services to user devices and/or the networks, facilitating communications between and among user devices of the microsegmented organizational networks 111, 127.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, a second user device 106, a third user device 112, a fourth user device 116, a fifth user device 122, a sixth user device 128, a non-organizational network 133, a non-organizational network 134, a non-organizational network 110, a microsegmented organizational network 111, a non-organizational network 126, a microsegmented organizational network 127, a communications network 135, a server 140, a server 145, a server 150, a server 160, edge devices 120, 132, and a database 155, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 121, store profiles for the networks of the system (e.g., hybrid, non-organizational, or organizational/work profiles), store characteristic data, indications that indicate whether a device is associated with an organization or not, information identifying the networks of the system 100, information including results of inspecting and/or analyzing of communications (e.g., such as to identify traffic types associated with communications that may be utilized to determine a device's associated to an organization or a non-organizational network) conducted by the system 100, store risk scores determined for a non-organizational network, microsegmented organizational network, and/or user, store information indicating whether device(s) of a non-organizational network may have certain types of limited interactions with device(s) of a microsegmented organizational network, store information identifying which devices are in the microsegmented organizational network and which devices are in the non-organizational network, store data shared by devices in the networks, store configuration information for the networks and/or devices of the system 100, store information relating to security controls and/or services provisioned to a device(s), store information obtained via probes conducted internally or externally with respect to a non-organizational network, store user profiles associated with the first and second users 101, 121, store device profiles associated with any device in the system 100, store communications traversing the system 100, store user preferences, store information associated with any device or signal in the system 100, store information relating to patterns of usage relating to the user devices, store any information obtained from any of the networks in the system 100, store historical data associated with the first and second users 101, 121, store device characteristics, store information relating to any devices associated with the first and second users 101, 121, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, gathering characteristic data associated with devices; determining whether the characteristic data indicates that the devices and/or activities conducted by the devices are associated with an organizational network or with a user's non-organizational network; creating non-organizational profiles, organizational or work profiles, and/or hybrid profiles; automatically generating a microsegmented organizational network from the non-organizational network that is separately accessible and secured from other devices of the non-organizational network that are not in the microsegmented organizational network; inspecting and/or analyzing communications of devices in the microsegmented organizational network; determining risk scores based on inspecting and/or analyzing the communications of devices in the microsegmented organizational network, characteristics of the non-organizational network and/or microsegmented organizational network, and/or other information; provisioning security protocols to a device of the microsegmented organizational network; enabling the device of the microsegmented organizational network to communicate subject to the security protocols; determining whether a user has consented to inspection, analysis, and/or scanning of devices in the non-organizational network; preventing inspection, analysis, and/or scanning of communications of devices in the non-organizational network; conducting limited inspection, analysis, and/or scanning of devices of a non-organizational network for which a user has provided consent for inspection, analysis, and scanning; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIGS. 1-2 illustrates specific example configurations of the various components of the system 100, the system 100 may include any configuration of the components, which may include using a greater or lesser number of the components. For example, the system 100 is illustratively shown as including a first user device 102, a second user device 106, a third user device 112, a fourth user device 116, a fifth user device 122, a sixth user device 128, a non-organizational network 133, a non-organizational network 134, a non-organizational network 110, a microsegmented organizational network 111, a non-organizational network 126, a microsegmented organizational network 127, a communications network 135, a server 140, a server 145, a server 150, a server 160, edge devices 120, 132, and a database 155. However, the system 100 may include multiple first user devices 102, multiple first user devices 102, multiple second user devices 106, multiple third user devices 112, multiple fourth user devices 116, multiple fifth user devices 122, multiple sixth user devices 128, multiple non-organizational networks 133, multiple non-organizational networks 134, multiple non-organizational networks 110, multiple microsegmented organizational networks 111, multiple non-organizational networks 126, multiple microsegmented organizational networks 127, multiple communications networks 135, multiple servers 140, multiple servers 145, multiple servers 150, multiple servers 160, multiple edge devices 120, 132, and multiple databases 155, and/or any number of any of the other components inside or outside the system 100. Furthermore, in certain embodiments, substantial portions of the functionality and operations of the system 100 may be performed by other networks and systems that may be connected to system 100.

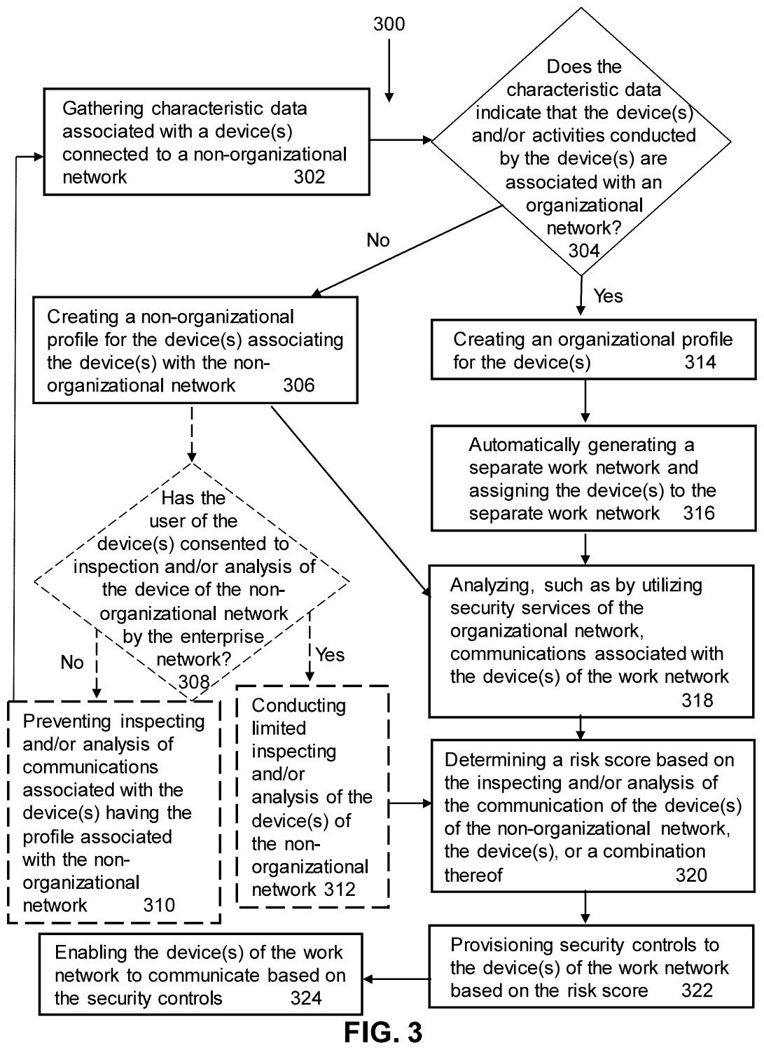

Referring now also to FIG. 3, an exemplary method 300 for providing and facilitating differentiation of devices for non-organizational network microsegmentation and device security status reporting according to embodiments of the present disclosure is illustrated. For example, the method of FIG. 3 can be implemented in the system of FIGS. 1-2 and/or any of the other systems, devices, and/or componentry illustrated in the Figures. In certain embodiments, the method of FIG. 3 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 3 may be performed at least in part by one or more processing devices (e.g., processor 102, processor 122, processor 141, processor 146, processor 151, and processor 161 of FIG. 1). Although shown in a particular sequence or order, unless otherwise specified, the order of the steps in the method 300 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 300 may include steps for obtaining, receiving, and/or collecting characteristic data associated with devices connected to a non-organizational network that may seek access to an organization, determining whether the devices are associated with the organization based on the characteristic data, generating non-organizational, organizational, or hybrid profiles based on the association determined from the characteristic data, automatically microsegmenting non-organizational devices and work devices by placing them into automatically generated non-organizational and microsegmented organizational networks, inspecting and/or analyzing communications by the devices in the microsegmented organizational networks, preventing inspection, analysis, and/or scanning of communications of the devices in the non-organizational networks (unless consented to), provisioning security controls from the organizational network to the devices of the microsegmented organizational networks, and facilitating communication and interaction of the devices of the microsegmented organizational network with other devices of the network and/or the organization, such as via the organizational network.

At step 302, the method 300 may include gathering characteristic data associated with a device connected to a non-organizational network of a user, such as non-organizational network 133. In certain embodiments, the characteristic data may be gathered from some or all of the devices in the non-organizational network 133. In certain embodiments, the characteristic data may be gathered only from the devices in the non-organizational network attempting to connect to and/or communicate with the organizational network 135. In certain embodiments, the characteristic data may include, but is not limited to, data indicating data being accessed or attempted to be accessed by the device is associated with the organizational network, applications executing on the device are associated with the organizational network, network activity conducted by the device, time-of-day of the user of the device, network traffic coming to or from the device, presence of security tools on the device and/or interacting with the device, files being modified and/or accessed by the device, a type of the device, network connections made by the device, data requested by the device, content accessed by the device (e.g., organizational websites and/or databases), other characteristic data, or a combination thereof. In certain embodiments, the gathering of the characteristic data may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 304, the method 300 may include determining whether the characteristic data indicates that the device(s) and/or activities conducted by the device(s) are associated with an organizational network (e.g., communications network 135). For example, in certain embodiments, the characteristic data may be indicative of being associated with the organizational network if the device(s) is attempting to access organizational network resources (e.g., websites, devices, data, applications, systems, devices of other workers of the organization), based on the device(s) using applications known to be associated with the organizational network or are interacting with the organizational network, if the device is a type of device that is typically utilized with the organizational network, if the device(s) are attempting to connect or are already connected to the organizational network, if the device(s) is interacting with or includes a software agent of the organization, if the device(s), if the user is logged into an application of the organization, if the media access control address is whitelisted by the organization or is known by the organization to be a device with authorization to interact with the organizational network, based on network activity of the device(s), based on a security tool of the device(s), based on a type of the device(s), based on any other factors, or a combination thereof. In certain embodiments, the determining of whether the device and/or activities conducted by the device are indicative of the device(s) being associated with the organization may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

If, at step 304, the characteristic data indicates that the device(s) and/or activities conducted by the device(s) are not associated with the organization, the method 300 may proceed to step 306. At step 306, the method 300 may include creating a non-organizational profile for the device(s) associating the device(s) with the non-organizational network of the user (e.g., first user 101). In certain embodiments, the non-organizational profile may include any of the characteristics of the device(s) (e.g., type of device, identifier of the device (e.g., MAC address, IP address, model of device, software versions of software on the device, etc.), information any or all device(s) belonging to the non-organizational network and are not associated with a microsegmented organizational network and/or the organizational network, information identifying a service provider of the non-organizational network, information indicating that the devices(s) associated with the non-organizational profile cannot access the organizational network and/or a microsegmented organizational network, a risk score for the non-organizational network, any other information, or a combination thereof. In certain embodiments, the creation of the non-organizational profile may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 308, which may be an optional step, the method 300 may include determining if the user of the device(s) of the non-organizational network (e.g., that are associated with or tied to the non-organizational profile) has consented to inspection, analysis, and/or scanning of the device(s) of the non-organizational network by the organizational network (e.g., communications network 135). In certain embodiments, consent may be assumed, such as if scanning of the device of the non-organizational network is not going to be conducted and only inspecting and/or analyzing of communications from and/or to the device of the non-organizational network. In such a scenario, the method 300 may jump from step 306 to a modified version of step 318 that involves analyzing and/or inspecting traffic of the device for the non-organizational network and then proceeding to step 320. In certain embodiments, for example, devices and/or applications of the organizational network may prompt the user via the first user device 102 for consent or the user may be prompted for consent via a software agent interacting with and/or executing on the device(s). In certain embodiments, the determining of whether consent to inspection, analysis, and/or scanning has been provided may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. If, at step 308, the method 300 determines that the user has not consented to inspection, analysis, and/or scanning of the device(s) by the organizational network, the method 300 may proceed to step 310. At step 310, the method 300 may include preventing inspection, analysis, and/or scanning of communications associated with the device(s) of the non-organizational network (e.g., having the non-organizational profile). In certain embodiments, the preventing of inspection, analysis, and scanning of communications associated with the device(s) may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. In certain embodiments, the method 300 may then proceed back to step 302 and proceed accordingly.

If, however, at step 308, the method 300 includes determining that the user of the device(s) has consented to inspection, analysis, and/or potentially scanning of the device(s) of the non-organizational network by the organizational network, the method 300 may proceed to step 312. At step 312, the method 300 may include conducting limited inspection, analysis, and/or scanning of the device(s) of the non-organizational network. In certain embodiments, limited inspection, analysis, and/or scanning may include only examining certain types of connections made by the device(s), examining only connections and/or types of connections existing for and/or made by the device(s) at a particular time of day, examining categories of types of content accessed by the device(s) rather than the specific content accessed by the device(s) (e.g., category or risky websites accessed instead of the actual uniform resource locators (URLs) of the website accessed by the user), examining the type of security programs (e.g., antivirus, firewalls, etc.) utilized by the device(s), examining whether a software agent of the organization is installed on the device(s), examining the types of applications installed and/or being accessed by the device(s), any information or process consented to by the user, or a combination thereof. In certain embodiments, the user may specify what can or cannot be accessed via the inspection, analysis, and/or scanning by the organizational network, such as when providing the consent. In certain embodiments, the conducting of the limited inspection, analysis, and/or scanning may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

In certain embodiments, the method 300, from step 312, may proceed to step 320. At step 320, the method 300 may include determining (or supplementing) a risk score based on the inspection and/or analysis of the communications of the device(s), the characteristics of the device(s), the characteristics of the non-organizational network, any other information, or a combination thereof. In certain embodiments, the risk score may serve as a snapshot of the user and/or the user's non-organizational network that provides insight into the riskiness of the non-organizational network and/or devices associated therewith with respect to the organization. For example, the existence in the non-organizational network of internet-connected television devices may raise the risk score because such devices may be vulnerable on the network to malware or hack attempts. Similarly, if the device(s) typically access websites known to be associated with phishing, fraud, malware, and the like, such information may be utilized to raise the risk score. In certain embodiments, the risk score may be on a scale from 0-100 with 100 being the highest, however, in certain embodiments, the risk score may be expressed as a percentage, as an emoticon (e.g., smiley face means low threat and frown means high threat), by a digital meter (e.g., the meter may comprise a plurality of bars where a score displayed on the meter via red bars is high risk, yellow bars are moderate risk, and green bars are high risk), expressed in any other desired manner, or a combination thereof. In certain embodiments, the determining of the risk score may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

The method 300 may proceed to step 322, which may include provisioning security controls to the devices of the microsegmented organizational network (discussed in further detail below) (or even the non-organizational network if consented to by the user) by the organizational network based on the information obtained based on the limited inspection, analysis, and/or scanning from step 312 and the risk score (or supplemented risk score if there are device(s) in a microsegmented organizational network separate from the non-organizational network). In certain embodiments, the security controls may include, but are not limited to, an identification of types of websites that may be accessed by device(s), firewall rules, types of antivirus software to be installed on the device(s), types of connections that may be made by the device(s), types of content that may be accessed or transmitted by the device(s), types of other types of software necessary for the device(s) (e.g., software agent of the organization or version of the software agent), preventing communications to certain devices, applications, and/or systems, or a combination thereof. In certain embodiments, the provision of the security controls to the devices may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. The method 300 may then proceed to step 324, which may include enabling the device(s) of the microsegmented organizational network (or potentially the non-organizational network if consented to by the user) to communicate via the security controls. In certain embodiments, the enabling of the communication via the security controls may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

If, however, at step 304, the method 300 includes determining that the characteristic data indicates that the device(s) and/or activities conducted by the device(s) are associated with the organizational network. The method 300 may then proceed to step 314. At step 314, the method 300 may include generating an organizational profile (or work profile) for the device(s) associating the device(s) with the organization (and/or a microsegmented organizational network). In certain embodiments, the organizational profile may include any of the characteristics of the device(s) (e.g., type of device, identifier of the device (e.g., MAC address, IP address, model of device, software versions of software on the device, etc.), information any or all device(s) belonging to a microsegmented organizational network and/or the organizational network, information identifying a service provider of the non-organizational network, information indicating that the devices(s) associated with the organizational profile can access the organizational network and/or a microsegmented organizational network, a risk score for the non-organizational network, any other information, or a combination thereof. In certain embodiments, the creation of the organizational profile may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 316, the method 300 may include facilitating generation of and/or generating a microsegmented organizational network (e.g., microsegmented organizational network 111), automatically and/or manually, from the non-organizational network that is separately accessible from the non-organizational network and assigning the device(s) determined to be associated with the organization to the microsegmented organizational network. In certain embodiments, facilitating generation of the network may include, but is not limited to, directly generating the network, assisting a device to create the network, assisting a program to create the network, transmitting a signal and/or instructions to a device, program, or system to cause the network to be created by the recipient of the signal and/or instructions, or a combination thereof. The process of generating the microsegmented organizational network that is separately accessible from the non-organizational network may be described as conducting microsegmentation. For example, in certain embodiments, the microsegmented organizational network may have a different identifier, name, login credentials, security controls, access permissions, any other distinguishing features from the non-organizational network, or a combination thereof. In certain embodiments, the microsegmented organizational network may be configured to be compliant with policies of the organization controlling the organizational network. In certain embodiments, only a device(s) determined to be associated with the organization may connect to and/or communicate with the microsegmented organizational network. In certain embodiments, assigning a device to the microsegmented organizational network may include enabling connection to the microsegmented organizational network, assigning an identifier in the system 100 that indicates that the device is a part of the microsegmented organizational network and/or is subject to the policies of the microsegmented organizational network, or a combination thereof. In certain embodiments, only the microsegmented organizational network may be configured to connect to or communicate with the organizational network and/or other systems, devices, programs, and/or resources of the organization. In certain embodiments, the generating of the microsegmented organizational network from the non-organizational network may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 318, the method 300 may include inspecting and/or analyzing communications and/or other activities made to or by the device(s) of the microsegmented organizational network. In certain embodiments, the inspecting and/or analyzing of the communications may be performed using security services (e.g., SASE services) provided by the organizational network, which, in certain embodiments, may be directly from componentry and devices of the organizational network. In certain embodiments, the inspecting and/or analyzing may be performed by a software agent of the organizational network that is installed on or otherwise made accessible to the device(s) of the microsegmented organizational network. In certain embodiments, in contrast with potential inspection and/or analysis of the non-organizational network, inspection and/or analysis of the device(s) activity in the microsegmented organizational network may encompass inspecting and/or analyzing more types of data and activities. For example, inspection and/or analysis of the device(s) may include inspecting and/or analyzing the specific websites accessed or connected to, the specific device identifies that the device(s) connects and/or communicates with, the documents that are accessed, the applications that are connected to and/or communicated with, an identification of specific times that the device(s) are used, the specific users that the user of the device(s) communicates with, the specific ports utilized to make connections with other devices, systems, and/or applications, the specific software installed and the versions of the software, the media content being consumed or experienced by a user of the device(s), the specific type of device(s) along with its components and capabilities, the network traffic coming to or from the device(s), a frequency (and the type) of using third party tools which may be related to work-related activities or not, a number of users using the device(s), identities of users using the device(s), demographic information or other personal information for the users of the device(s), whether the device(s) is connecting to a device, program, and/or system outside the microsegmented organizational network and/or organizational network, the type of firewall and version of the firewall being used on the device(s), the types of security programs (e.g., antivirus) being used on the device(s), any other information, or a combination thereof. In certain embodiments, the inspecting and/or analyzing of the communications and/or activities made to or by the device(s) may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 320, the method 300 may include determining a risk score associated with the user, the non-organizational network, the device(s), the microsegmented organizational network, or a combination thereof. In certain embodiments, the risk score may serve as a snapshot of the worker and their home and may be utilized as an informing factor to the organization of what the overall or cumulative risk is for the user and the user's associated network(s) and device(s). For example, as indicated above, the risk score may be on a scale from 0-100 with 100 being the highest, however, other scales or techniques for expressing the score may also be utilized including, but not limited to, visual representations, number-based representations, word or phrase-based representations, audio representations, augmented reality representations, virtual reality representations, any other types of representations, or a combination thereof. In certain embodiments, for example, the risk score associated with a worker that is married, has three children of certain ages, has risky devices (e.g., internet-connected television), and for which parental controls have failed in the non-organizational network, the system 100 may determine has a higher risk score than a family that comprises a couple with no children that has installed a variety of security programs on the device(s) of the non-organizational network and/or microsegmented organizational network. In certain embodiments, such as if the worker of the organization has consented to inspection, analysis, and/or scanning (e.g., limited inspection, analysis, and/or scanning) of device(s) that are on the non-organizational network that is separately accessible from the microsegmented organizational network, the information gleaned from the inspection, analysis, and/or scanning may be utilized to supplement the risk score generated to provide a more robust risk score of the user, the non-organizational network, the microsegmented organizational network, and the associated device(s). In certain embodiments, the risk score may be continually calculated, calculated at random times, calculated at periodic intervals, or at any other fashion. In certain embodiments, the determining of the risk score may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 322, the method 300 may include provisioning security controls and/or services to the device(s) of the microsegmented organizational network. In certain embodiments, the security controls may be provisioned in accordance with the risk score determined from step 320. In certain embodiments, more security controls and/or different types of security controls may be provisioned as the risk score increases. Similarly, in certain embodiments, fewer security controls and/or different types of security controls may be provisioned as the risk score decreases. In certain embodiments, the security controls may dictate what outbound ports of the microsegmented organizational network that the device(s) may use, what type of firewall the device(s) should use, the type of security programs (e.g., antivirus) that the device(s) needs to use, the software versions of software that the device(s) needs to use, that inbound port scans should be prevented, that server message block (SMB) requests should be prevented, that certain types of content, applications, devices, and/or systems cannot be accessed, that service provided by the service provider for the non-organizational network and/or microsegmented organizational network needs to be upgraded or updated, that the edge device 120 needs to be upgraded or updated, that the device(s) need to be upgraded or updated, that a software agent of the organization needs to be installed or updated on the device(s), that all communications made by or to the device(s) of the microsegmented organizational network are to be encrypted or passed through a virtual private network, any other security controls, or a combination thereof. In certain embodiments, the provisioning of the security controls and/or services may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 324, the method 300 may include enabling the device(s) of the microsegmented organizational network to communicate using the security controls and/or services, subject to the security controls and/or services, or a combination thereof. In certain embodiments, for example, all communications emanating from a device(s) of the microsegmented organizational network may need to be encrypted and pass through a virtual private network. As another example, the device(s) may be prevented from communicating with device(s) on the non-organizational network—at least for organization-related information, content, and/or activities. In certain embodiments, the enabling of the device(s) of the microsegmented organizational network to communicate using the security controls and/or services may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. In certain embodiments, the method 300 may be repeated as desired and any of the functionality described in the present disclosure may be incorporated into the method 300. In certain embodiments, functionality of the method 300 may be combined with other methods (e.g., methods 400, 500) described in the present disclosure. In certain embodiments, certain steps of the method 300 may be replaced with other functionality of the present disclosure and the sequence of steps may be adjusted as desired.

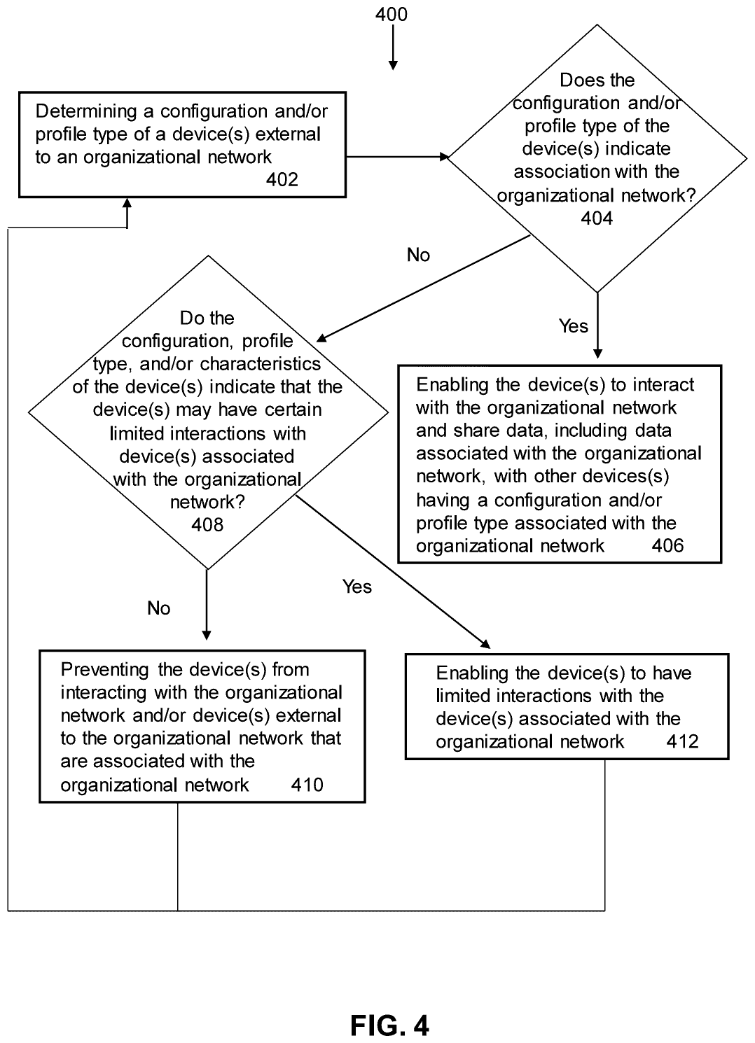

Referring now also to FIG. 4, FIG. 4 illustrates an exemplary method for determining a configuration and profile type of a device to determine whether a device can interact with an organizational network according to embodiments of the present disclosure. For example, as with the method 300 of FIG. 3, the method of FIG. 4 can be implemented in the system of FIGS. 1-2 and/or any of the other systems, devices, and/or componentry illustrated in the Figures. In certain embodiments, the method of FIG. 4 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 4 may be performed at least in part by one or more processing devices (e.g., processor 102, processor 122, processor 141, processor 146, processor 151, and processor 161 of FIG. 1). Although shown in a particular sequence or order, unless otherwise specified, the order of the steps in the method 400 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Generally, the method 400 may include a step for determining the configuration and profile type of a device(s) that is external to an organizational network. The method 400 may also include a step for determining if the configuration and/or profile indicates an association with the organizational network. Additionally, the method 400 may include enabling a device(s) to interact with the organizational network and share data with other devices that are determined to have a configuration and/or profile type indicating association with the organizational network. In the event that the device(s) does not have a configuration and/or profile type associated with the organizational network and cannot have limited interactions with a device(s) associated with the organizational network, the method 400 may include preventing the device(s) from interacting with the organizational network and/or device(s) that are associated with the organizational network. If, however, the device(s) is able to have limited interactions with the device(s) associated with the organizational network, the method 400 may including enabling the device(s) of the non-organizational network to have the limited interactions of the device(s) associated with the organizational network, including device(s) of a microsegmented organizational network generated from the non-organizational network.

At step 402, the method 400 may include determining a configuration and/or profile type of a device(s) that is external to an organizational network. In certain embodiments, the configuration of the device(s) may include what types of outbound ports the device(s) accesses, the type of device that the device(s) is, the componentry of the device(s) (e.g., memory, processor, communication modules, display capabilities, audio capabilities, microphone, speaker, etc.), the software installed on the device(s), the type of internet connection utilized by the device(s), the security programs and/or controls on the device(s) and settings relating thereto, the users that user the device(s), the types of connections that the device(s) accepts or makes, the networks that the device(s) are connected to or connect to, the profile type of the device(s), an operating system of the device(s), any other configuration aspect of the device(s), or a combination thereof. In certain embodiments, the profile type may include, but is not limited to, a non-organizational profile, an organizational or work profile, a hybrid profile (e.g., a profile for a mobile or other device that allows access to the microsegmented organizational network and the non-organizational network), any other profile, or a combination thereof. In certain embodiments, the determining of the configuration and/or profile type may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

At step 404, the method 400 may include determining if the configuration and/or profile type of the device(s) indicates an association with the organization, organizational network, or a combination thereof. In certain embodiments, for example, the configuration may be indicative of being associated with the organization if the device(s) has a software agent of the organization installed on the device(s), the device(s) utilizes applications that the organization utilizes, the device(s) connects to devices, programs, and/or applications of the organization, the device(s) communicates with device(s) of the microsegmented organizational network, the device(s) has componentry that matches or communicates with componentry of the organization, has security programs of the organization installed on the device(s), accesses ports associated with the organization, complies with policies of the organization, has other characteristics or conducts behaviors or actions associated with the organization, or a combination thereof. In certain embodiments, if the profile type is a work profile or a hybrid profile, either profile may be indicative of an association with the organization. In certain embodiments, the determining of whether the configuration and/or profile of the device(s) indicates the association with the organization may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

If, at step 404, the method 400 includes determining that the configuration and/or profile type of the device(s) indicates an association with the organization, the method 400 may proceed to step 406. At step 406, the method 400 may include enabling the device(s) to interact with the organizational network and share data and communications with other device(s) having a configuration and/or profile type indicating association with the organization and/or organizational network. For example, the device(s) may be allowed to share data with other device(s) of the microsegmented organizational network and communicate with device(s) of the organizational network and vice versa. In certain embodiments, the determining of the configuration and/or profile type indicating association with the organizational network may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

If, however, at step 404, the method 400 includes determining that the configuration and profile type of the device(s) does not indicate association with the organization, organizational network, or a combination thereof, the method 400 may proceed to step 408. At step 408, the method 400 may include determining whether the configuration, profile type, and/or characteristics of the device(s) indicate that the device(s) may have certain limited interactions with other device(s) associated with the organization. For example, even though the device(s) is not associated with the organizational network, the device(s) may be a printer and may be configured to perform the limited interaction of receiving requests to print documents from a device(s) of the microsegmented organizational network. In certain embodiments, the determining may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device.

If, at step 408, the method 400 includes determining that the configuration, profile type, and/or characteristics of the device(s) indicate that the device(s) cannot have limited interactions with device(s) or other devices associated with the organization, the method 400 may proceed to step 410. At step 410, the method 400 may include preventing the device(s) from interacting with the organizational network and/or device(s) external to the organizational network that are associated with the organizational network. In certain embodiments, the preventing of the interactions may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. In certain embodiments, the method 400 may proceed to back to step 402 and repeat the steps of the method 400.

If, however, at step 408, the method 400 determines that the configuration, profile type, and/or characteristics of the device(s) indicate that the device(s) can have limited interactions with device(s) or other devices associated with the organization, the method 400 may proceed to step 412. At step 412, the method 400 may include enabling the device(s) to participate in the limited interactions with the device(s) associated with the organization, organizational network, or a combination thereof. In certain embodiments, the specific interactions that are allowed may be specified within a hybrid or work profile. In certain embodiments, the organizational network itself or a software agent associated with the organizational network may specify the specific types of limited interactions that may be conducted, which may be tailored to the configuration and/or characteristics of the device(s). In certain embodiments, the enabling of the participation in the limited interactions may be performed and/or facilitated by utilizing the first user device 102, the second user device 122, the server 140, the server 145, the server 150, the server 160, the communications network 135, any component of the system 100, any combination thereof, or by utilizing any other appropriate program, network, system, or device. The method 400 may then proceed to step 402 and repeat the process as desired, which may be on a continuous basis, periodic basis, or at designated times. Notably, the method 400 may incorporate any of the other functionality as described herein and may be adapted to support the functionality of the system 100. In certain embodiments, functionality of the method 400 may be combined with other methods (e.g., methods 300, 500) described in the present disclosure. In certain embodiments, certain steps of the method 400 may be replaced with other functionality of the present disclosure and the sequence of steps may be adjusted as desired.

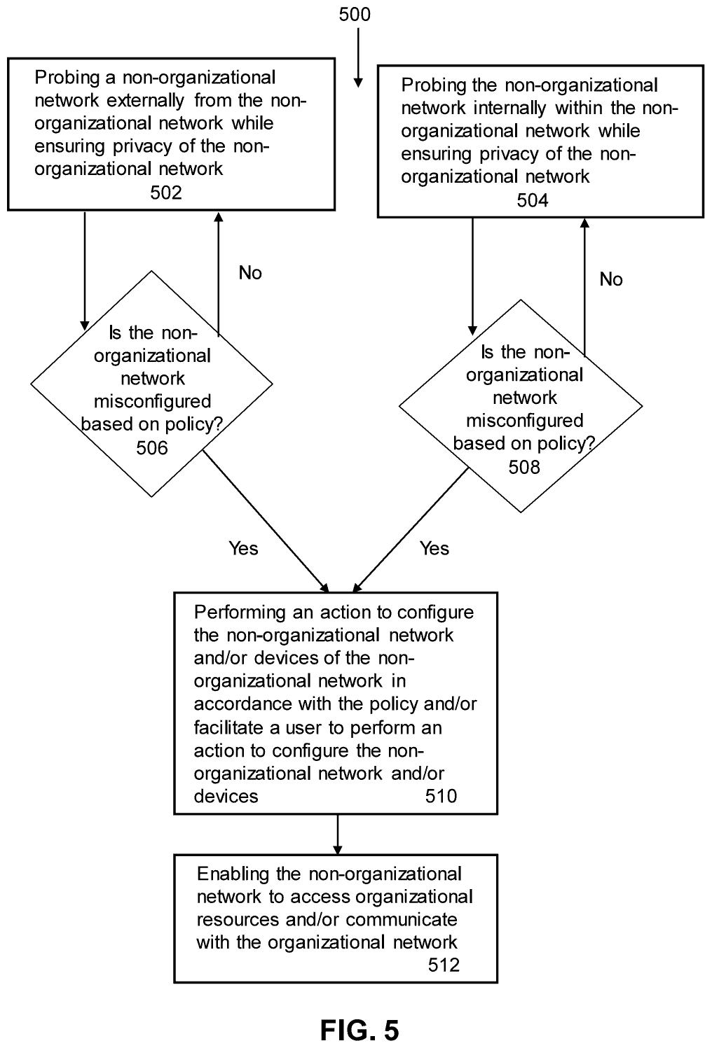

Referring now also to FIG. 5, FIG. 5 illustrates an exemplary method 500 for probing a non-organizational network externally and internally to determine misconfiguration of a non-organizational network according to embodiments of the present disclosure. For example, as with the methods 300, 400 of FIGS. 3 and 4, the method of FIG. 5 can be implemented in the system of FIGS. 1-2 and/or any of the other systems, devices, and/or componentry illustrated in the Figures. In certain embodiments, the method of FIG. 5 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 5 may be performed at least in part by one or more processing devices (e.g., processor 102, processor 122, processor 141, processor 146, processor 151, and processor 161 of FIG. 1). Although shown in a particular sequence or order, unless otherwise specified, the order of the steps in the method 500 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Generally, the method 500 may include a steps for probing a non-organizational network externally from the non-organizational network and probing the non-organizational network internally within the non-organizational network. Notably, the method 500 may conduct the probing while also ensuring privacy of the user of the non-organizational network. The method 500 may also include steps for determining whether the non-organizational network is misconfigured based on the requirements of one or more organization policies of an organization. If the non-organizational network is misconfigured, the method 500 may include performing an action to configure the non-organizational network and/or devices of the non-organizational network to conform with the one or more organization policies of the organization. In certain embodiments, the user may be prompted to perform any number of actions to configure the non-organizational network and/or devices of the non-organizational network to conform to one or more policies of the organization. The method 500 may also include enabling the non-organizational network and/or devices connected thereto to access organizational resources and/or communicate with the organizational network.

At step 502, the method 500 may include probing a non-organizational network externally from the non-organizational network to determine if the non-organizational network is misconfigured. In certain embodiments, the probing may be conducted in a manner that ensures the privacy of the non-organizational network. For example, in certain embodiments, the organizational network may probe the non-organizational network by conducting a periodic port scan to the outside internet protocol address for the worker's non-organizational network (e.g., by using IPv4, IPv6, or both). In certain scenarios, the user (i.e., worker) may not be aware of misconfigurations of the non-organizational network and there may be other users in the user's home that may have the ability to modify the non-organizational network configuration. For example, certain users may be able to utilize certain ports for activities, such as playing online video games. In certain embodiments, the probing of the non-organizational network externally from the non-organizational network may be performed and/or facilitated by utilizing the server 140, the server 145, the server 150, the server 160, the communications network 135, any component of the system 100, any combination thereof, or by utilizing any other appropriate program, network, system, or device.

At step 504, the method 500 may include probing the non-organizational network from within the non-organizational network to assess if the non-organizational network is misconfigured. In certain embodiments, for example, the probing from within the non-organizational network may be conducted by a software agent installed on a device(s) of the non-organizational network. In certain embodiments, the probing of the non-organizational network internally within the non-organizational network may be performed and/or facilitated by utilizing the server 140, the server 145, the server 150, the server 160, the communications network 135, any component of the system 100, any combination thereof, or by utilizing any other appropriate program, network, system, or device. In certain embodiments, the probing conducted at steps 502 and 504 may provide information identifying some or all of the devices connected to the non-organizational network, attempts to login to the non-organizational network administrative panel from the inside or outside, information resulting from tests for determining whether default passwords or credentials for the non-organizational router (e.g., edge device 120) are still in use, the types of firewalls used, the types of security programs used in the non-organizational network, the ports accessed by devices of the non-organizational network, the types of content accessed by the non-organizational network, whether the devices in the non-organizational network are attempting to access the organization, whether the network bandwidth usage is above or below a threshold, software versions of software running in the non-organizational network and/or devices of the non-organizational network, any other information, or a combination thereof.

At steps 506 and 508, which may be conducted simultaneously or at different times, the method 500 may include determining if the non-organizational network is misconfigured, such as based on organizational policies that set or are to be set for the non-organizational network (e.g., such as to a microsegmented organizational network generated from the non-organizational network) by the organization. In certain embodiments, the determining of a misconfiguration may be performed and/or facilitated by utilizing the server 140, the server 145, the server 150, the server 160, the communications network 135, any component of the system 100, any combination thereof, or by utilizing any other appropriate program, network, system, or device. In certain embodiments, the non-organizational network and/or devices of the non-organizational network may be misconfigured if the network and/or devices connected to the network do not comply with policies of the organization. If, at steps 506 or 508, the non-organizational network is determined not to be misconfigured, the method 500 may revert back to steps 502 and/or 504 until a misconfiguration is detected. If, at steps 506 and/or 508, the non-organizational network is determined to be misconfigured, the method 500 may proceed to step 510.

At step 510, the method 500 may include performing an action to configure the non-organizational network and/or devices of the non-organizational network to conform the non-organizational network and/or devices to the requirements of policies of the organization. In certain embodiments, at step 510, the method 500 may also include facilitating a user to configure the non-organizational network and/or devices of the non-organizational network to conform to the requirements of the policies of the organization. In certain embodiments, the performing of the action may be performed and/or facilitated the users and/or by utilizing the server 140, the server 145, the server 150, the server 160, the communications network 135, any component of the system 100, any combination thereof, or by utilizing any other appropriate program, network, system, or device. In certain embodiments, the action may include providing guidance and/or automated ability to (e.g., with the user's consent and providing access credentials to the non-organizational network's admin panel) update the network configuration. For example, the system 100 may check the router version (e.g., the edge device 120) to determine if it is up-to-date, or has vulnerabilities and needs patching, and initiate the patch activity to update the router version. In certain embodiments, an exemplary action may include ensuring that IPv6 privacy features are enabled (e.g., as defined in rfc 4941 “Privacy Extensions for Stateless Address Autoconfiguration in IPV6). In certain embodiments, the action may include prompting the user to do MAC address whitelisting (e.g., based on an initial inventory of connected devices to simplify the user interface for the worker, for devices which do not do MAC address randomization).

In certain embodiments, for example, the internet service provider of the user may be detected and the system 100 may provide the worker (i.e., user) with links for help and/or support specific to the particular internet service provider. In certain embodiments, the action may include conducting periodic network speed tests to ensure that the worker's non-organizational network has the capacity required by the organization to perform work from the non-organizational network. In certain embodiments, the action may include disabling features of the non-organizational network and/or device(s) of the non-organizational network (e.g., disabling universal plug and play features, disabling certain ports, disabling access to certain websites and/or content, etc.). In certain embodiments, the action may include examining and modifying (or prompt to modify) the non-organizational network service set identifier (SSID) to ensure that the SSID is unique and does not contain personally identifiable information (e.g., the worker's name or address, etc.). In certain embodiments, the system 100 may provide support and/or help to facilitate the user (i.e., worker) to make changes if necessary to comply with organization policies. In certain embodiments, the action may include probing the non-organizational network for file sharing systems on network (e.g., service message block (SMB), Apple filing protocol (AFP), network file system (NFS), etc.). In certain embodiments, the organization policy may state that devices used by the worker cannot have open file sharing from such devices (i.e., the devices must be protected by user identifiers and passwords, for example). In certain embodiments, the action may include, but is not limited to, reconfiguring network settings, updating software of the non-organizational network and/or device(s), blocking certain devices from the non-organizational network, encrypting communications to or from the devices, providing a firewall, providing antivirus protection, conducting any other action, or a combination thereof.

Once the action is performed by the system 100 and/or the user performs the action based on a prompt or instructions from the system 100, the method 500 may proceed to step 512. At step 512, the method 500 may include enabling the non-organizational network and devices of the non-organizational network to access resources of the organization and/or communicate with the organizational network. In certain embodiments, at step 512, the method 500 may include enabling the devices of the non-organizational network to communicate with other devices associated with the organization. In certain embodiments, the enabling of the access and/or communications may be performed and/or facilitated the users and/or by utilizing the server 140, the server 145, the server 150, the server 160, the communications network 135, any component of the system 100, any combination thereof, or by utilizing any other appropriate program, network, system, or device. The method 500 may be repeated as desired, which may be on a continuous basis, periodic basis, or at designated times. Notably, the method 500 may incorporate any of the other functionality as described herein and may be adapted to support the functionality of the system 100. In certain embodiments, functionality of the method 500 may be combined with other methods (e.g., methods 300, 400) described in the present disclosure. In certain embodiments, certain steps of the method 500 may be replaced with other functionality of the present disclosure and the sequence of steps may be adjusted as desired.

In certain embodiments, the system 100 and methods may incorporate further functionality and features. For example, the system 100 and methods may be configured to support personal device management and/or bring your own management scenarios. For example, in such scenarios, software agents may be placed, such as at the worker's desire, on every other mobile or laptop device used in the worker's home location (e.g., for family members). The foregoing provides benefits for the worker, who can be assured of protection for family member devices, and for the organization, which can determine that other devices on the worker's non-organizational network are protected and do not represent attack surfaces, as long as all the individuals are assured that their privacy is being preserved by the organization (e.g., individual browsing activity, sites visited, etc. may not be reported to the organization). In certain embodiments, the system 100 and methods may provide availability to an organization administrator of the security state of the worker's non-organizational network. In certain embodiments, since the non-organizational network may essentially be an extension of the organizational network, the foregoing may provide visibility that is valuable to the organization. From a privacy perspective, information about whether the non-organizational network conforms to a specific organizational policy may be sent from the device(s) on the non-organizational network to the organizational administrator, administrative server, and/or admin console, without sending private details that the employee would not wish to share with the organization. The system 100 and methods provide the ability for the organization administrator to view across all users the security state of their non-organizational networks. In certain embodiments, some individuals (and their corresponding devices) may opt into the foregoing capability, and some may not, and the security posture assessment may be modified accordingly.

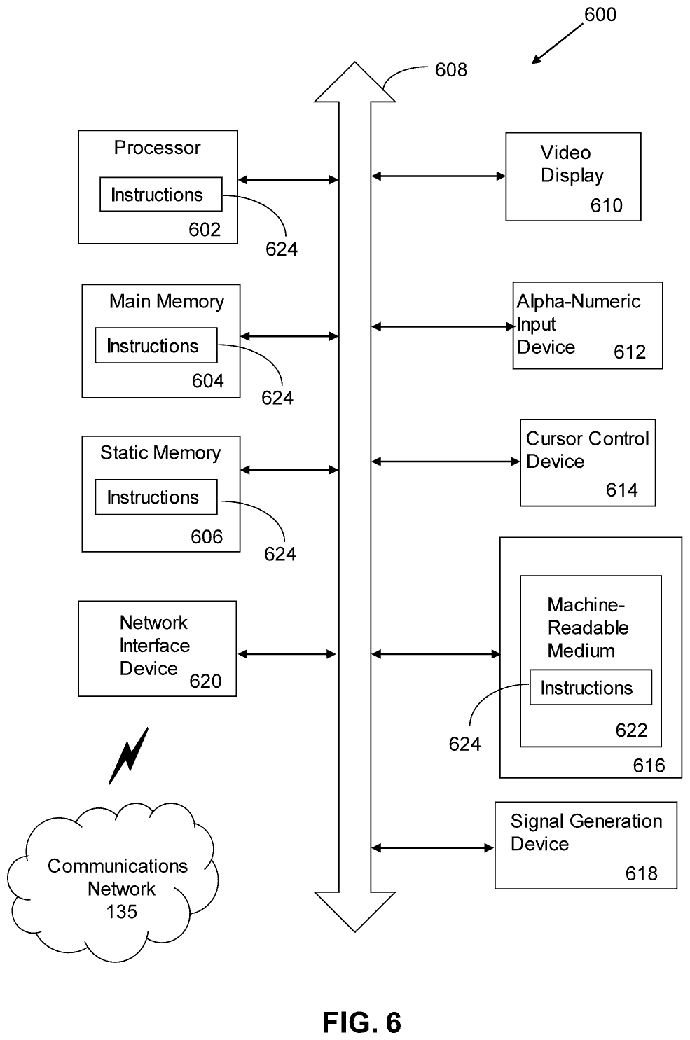

Referring now also to FIG. 6, at least a portion of the methodologies and techniques described with respect to the exemplary embodiments of the system 100 and/or methods 300, 400, 500 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 600 may assist in determining configurations and/or profile types of devices and/or networks of the system 100; determining whether the configurations and/or profile types are associated with an organizational network or non-organizational network; enabling devices of a microsegmented organizational network to interact with the organizational network and share data with other devices of the microsegmented organizational network; providing limited interactions between devices of a microsegmented organizational network and devices with a non-organizational network if consent is provided; preventing devices of a non-organizational network from interacting with the organizational network and/or microsegmented organizational network if consent has not been provided; providing a non-organizational network externally and/or internally; determining whether the non-organizational network is misconfigured based on enterprise policies; performing actions to configured the non-organizational network and/or devices of the non-organizational network to conform them to the policies of the organizational network; enabling the non-organizational network to access organizational resources and/or communication with the organizational network; calculating risk scores of a non-organizational network (or user); provisioning security controls to devices of microsegmented organizational networks based on risk scores; generating microsegmented organizational networks from non-organizational networks for device associated with an organization; generating profiles for devices based on association with an organizational network or non-organizational network, or both; and/or performing any other operations of the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the second user device 106, the third user device 112, the fourth user device 116, the fifth user device 122, the sixth user device 128, the non-organizational network 133, the non-organizational network 134, the non-organizational network 110, the microsegmented organizational network 111, the non-organizational network 126, the microsegmented organizational network 127, the communications network 135, the server 140, the server 145, the server 150, the server 160, edge devices 120, 132, and the database 155, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610, which may be, but is not limited to, a liquid crystal display (LCD), a flat panel, a solid-state display, or a cathode ray tube (CRT). The computer system 600 may include an input device 612, such as, but not limited to, a keyboard, a cursor control device 614, such as, but not limited to, a mouse, a disk drive unit 616, a signal generation device 618, such as, but not limited to, a speaker or control, and a network interface device 620.

The disk drive unit 616 may include a machine-readable medium 622 on which is stored one or more sets of instructions 624, such as, but not limited to, software embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 622 containing instructions 624 so that a device connected to the communications network 135, another network, or a combination thereof, can send or receive voice, video or data, and communicate over the communications network 135, another network, or a combination thereof, using the instructions. The instructions 624 may further be transmitted or received over the communications network 135, another network, or a combination thereof, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
a memory storing instructions; and
a processor configured to execute the instructions to cause the processor to be configured to;
obtain characteristic data associated with a device connected to a non-organizational network;
determine, based on the characteristic data, whether the device is associated with an organizational network;
facilitate, based on a determination that the device is associated with the organizational network, generation of a microsegmented organizational network from the non-organizational network that is separately accessible from the non-organizational network;
assign the device to the microsegmented organizational network;
analyze, by utilizing security services of the organizational network, communications from the device of the microsegmented organizational network;
provision a security control associated with the organizational network to the device of the microsegmented organizational network; and
enable the device of the microsegmented organizational network to communicate based on the security control.

2. The system of claim 1, wherein the processor is further configured to generate an organizational profile for the device based on the determination that the device is associated with the organizational network, wherein the organizational profile associates the device with the organizational network.

3. The system of claim 1, wherein the processor is further configured to generate a non-organizational profile for the device associating the device with the non-organizational network if the device is determined to not be associated with the organizational network.

4. The system of claim 1, wherein the processor is further configured to determine a risk score for the non-organizational network, the microsegmented organizational network, or a combination thereof, based on the analyzing of the communications from the device, a characteristic of the device, a characteristic of the non-organizational network, or a combination thereof.

5. The system of claim 4, wherein the processor is further configured to provisional the security control associated with the organizational network based on the risk score.

6. The system of claim 1, wherein the processor is configured to conduct limited inspecting of traffic associated with the device of the non-organizational network if a user has consented to the limited inspecting of the traffic associated with the device of the non-organizational network by the organizational network.

7. The system of claim 6, wherein the processor is further configured to utilize an output generated based on the limited inspecting of the traffic associated with the device of the non-organizational network to determine a risk score for the non-organizational network, the microsegmented organizational network, or a combination thereof.

8. The system of claim 1, wherein the processor is further configured to prevent the device of the microsegmented organizational network from communicating with a different device of the non-organizational network.

9. The system of claim 1, wherein the processor is further configured to generate a hybrid profile for the device if the device is determined to be associated with the organizational network and the non-organizational network.

10. The system of claim 9, wherein the processor is further configured to analyze, based on the hybrid profile, a first portion of the communications associated with the device occurring in the microsegmented organizational network, and wherein the processor is further configured to not analyze a second portion of the communications associated with the device occurring in the non-organizational network.

11. The system of claim 1, wherein the processor is further configured to analyze a characteristic of the non-organizational network, a characteristic of the device, or a combination thereof, to determine a risk score for the non-organizational network, wherein the characteristic of the non-organizational network comprises a quantity of devices in the non-organizational network, a type of internet connection supported by the non-organizational network, a service provider of the non-organizational network, a type of edge device of the non-organizational network, a bandwidth of the non-organizational network, security hardware of the non-organizational network, security software of the non-organizational network, or a combination thereof, wherein the characteristic of the device comprises a type of the device, a communication capability of the device, a type of componentry of the device, a software version of software of the device, whether the device is communicating with a type of device, or a combination thereof.

12. The system of claim 1, wherein the processor is further configured to enable the device of the microsegmented organizational network to communicate with at least one other device of the microsegmented organizational network.

13. A method, comprising:
analyzing, by utilizing instructions from a memory that are executed by a processor, characteristic data associated with a device connected to a non-organizational network;
determining, based on the characteristic data, whether the device is associated with an organizational network;
creating, based on determining that the device is associated with the organizational network, a microsegmented organizational network from the non-organizational network that is separately accessible from the non-organizational network;
analyzing, by utilizing the organizational network, communications associated with the device of the microsegmented organizational network;
provisioning, by utilizing the organizational network, a security control associated with the organizational network to the device of the microsegmented organizational network based on the communications analyzed by utilizing the enterprise network; and
enabling the device of the microsegmented organizational network to communicate with the organizational network using the security control.

14. The method of claim 13, further comprising probing the non-organizational network from outside the non-organizational network to determine whether the non-organizational network is misconfigured with respect to at least one policy associated with the organizational network.

15. The method of claim 14, further comprising probing the non-organizational network from within the non-organizational network to determine whether the non-organizational network is misconfigured with respect to the at least one policy associated with the organizational network.

16. The method of claim 15, further comprising facilitating reconfiguration of the non-organizational network to comply with the at least one policy associated with the organizational network by updating a network configuration of the non-organizational network, applying a software update to the non-organizational network, enabling a privacy feature, providing user instructions to a user of the device to reconfigure the non-organizational network, conducting a speed test of the non-organizational network, modifying an identifier of the non-organizational network, prevent filing sharing with certain types of systems, or a combination thereof.

17. The method of claim 13, further comprising determining compliance with at least one policy of the organizational network by analyzing traffic associated with the home network, the microsegmented organizational network, or a combination thereof, without accessing information a user of the non-organizational network designates as private, types of information indicated as private according to the at least one policy or the organizational network, or a combination thereof.

18. A non-transitory computer readable medium comprising instructions, which, when loaded and executed by a processor, cause the processor to be configured to:
receive characteristic data associated with a device connected to a non-organizational network;
determine, based on the characteristic data, whether the device is associated with an organizational network;
facilitate, based on determining that the device is associated with the organizational network, generation of a microsegmented organizational network separately accessible from the non-organizational network;
assign the device to the microsegmented organizational network;
analyze, by utilizing the organizational network, at least one communication associated with the device of the microsegmented organizational network;
provision a security control associated with the organizational network to the device of the microsegmented organizational network based on the at least one communication; and
adjusting the security control based on at least one additional communication.

19. The non-transitory computer readable medium of claim 18, wherein the processor is further configured to receive additional characteristic data associated with the device, and wherein the processor is further configured to remove or disconnect the device from the microsegmented organizational network if the additional characteristic data indicates that the device is no longer associated with the organizational network.

20. The non-transitory computer readable medium of claim 18, wherein the processor is further configured to enable the device of the microsegmented organizational network to interact with another device of the non-organizational network in accordance with the security control, at least one policy of an organization associated with the organizational network, or a combination thereof.
